(19) United States
(12) Patent Application Publication
(10) Pub. No.: US 2023/0186338 A1
(43) Pub. Date: Jun. 15, 2023

(54) GLOBAL MOBILE VOUCHER PLATFORM AND METHOD FOR SENDING MOBILE VOUCHER BETWEEN COUNTRIES USING THE SAME

(71) Applicant: COOP MARKETING, Seoul (KR)

(72) Inventor: Woo Jeong JEON, Goyang-si (KR)

(21) Appl. No.: 17/924,047

(22) PCT Filed: Jun. 11, 2021
(86) PCT No.: PCT/KR2021/007358

§ 371 Date: Nov. 8, 2022

(30) Foreign Application Priority Data
Jun. 22, 2020 (KR) 10-2020-0075642

(51) Int. Cl. G06Q 30/0207; G06Q 20/06; G06Q 20/32; G06Q 20/38; G06Q 20/40

(52) U.S. Cl. CPC G06Q 30/0222; G06Q 20/065; G06Q 20/322; G06Q 20/387; G06Q 20/405

(57) ABSTRACT

Provided are a global mobile gift certificate platform and a method for presenting a mobile gift certificate between countries based on a global mobile gift certificate platform. The global mobile gift certificate platform includes a main server which provides a mobile gift certificate service including mobile gift certificate management and mobile gift certificate issuance to a user terminal; and a brand server which provides a brand associated service including present of mobile gift certificate and reward payment to a user terminal of a customer of a brand, and the main server and the brand server are individually provided for each of a plurality of countries to provide the mobile gift certificate service and the brand associated service to each of the plurality of countries associated with the global mobile gift certificate platform.

### TECHNICAL FIELD

The present disclosure relates to a global mobile voucher (gift certificate) platform and a method for presenting a mobile gift certificate between countries based on a global mobile gift certificate platform.

### BACKGROUND ART

Generally, a mobile gift certificate (or voucher) refers to a swapping bond which is offered through mobile, has a specific monetary value, and can be consumed for a specific product or service. Specifically, the mobile gift certificate is an exchange ticket including a right to request the provision of goods or services specified in the gift certificate and is issued with a format of a barcode, a QR code, a mobile, or a web page accessible URL, or a random number type of PIN number.

Recently, it is common for users to purchase mobile gift certificates through various channels and use them for themselves or to present them to a third party. In addition to the direct purchasing method, various financial service institutions, telecommunication service companies, business operators, organizations are increasingly giving mobile gift certificates as benefits for customers or providing reward services such as mobile gift certificates, stamps, or discount coupons.

However, the mobile gift certificate service of the related art is generally operated to be limited in a user’s country so that the user may purchase or present only mobile gift certificates available in the corresponding country so that a service which allows a user to directly use the mobile gift certificate in foreign countries or present the mobile gift certificates overseas to the third parties in the other countries has not been provided. Further, when the user tries to use the overseas mobile gift certificate service, mobile gift certificate services provided for every country are not unified, which causes the inconvenience of the users.

Further, even in view of a brand which wants to sell a predetermined product or service based on the mobile gift certificate, there is a difficulty to separately build a platform or a system which provides a mobile gift certificate service for every country in which the brand has entered. Further, it is difficult for a small size brand which does not have a mobile gift certificate service to have a means for providing products or services which are provided by the brand as mobile gift certificates or easily managing rewards such as stamp accumulation, discount benefits, or events so that it is difficult to perform the promotion by utilizing mobile gift certificates.

A related art of the present disclosure is disclosed in Korean Registered Patent Publication No. 10-1745800.

### DISCLOSURE

### Technical Problem

In order to solve the above-described problems of the related art, an object to be achieved by the present disclosure is to provide a global mobile gift certification platform and a method for presenting a mobile gift certificate between countries based on a global mobile gift certificate platform which are capable of providing a mobile gift certificate service which is provided for a customer to buy a mobile gift certificate or present the mobile gift certificate to a third party and a brand-associated service related to a customer relationship management (CRM), such as, a benefit, a reward, or mobile gift certificate payment provided to a customer by a brand.

However, objects to be achieved by various embodiments of the present disclosure are not limited to the technical objects as described above and other technical objects may be present.

### Technical Solution

As a technical means to achieve the above-described technical object, according to an aspect of the present disclosure, a global mobile gift certificate platform may include a main server which provides a mobile gift certificate service including mobile gift certificate management and mobile gift certificate issuance to a user terminal; and a brand server which provides a brand associated service including present of mobile gift certificate and reward payment to a user terminal of a customer of a brand.

Further, the main server and the brand server may be individually provided for each of a plurality of countries to provide the mobile gift certificate service and the brand associated service to each of the plurality of countries associated with the global mobile gift certificate platform.

Further, the main server may hold an associated company registration right and an associated company deletion right and a right to register a mobile gift certificate associated with the registered associated company and a right to delete the mobile gift certifi cate.

Further, the mobile gift certificate registration right may be a right to register at least one of a first type mobile gift certificate which has been provided in advance by the registered associated company and a second type mobile gift certificate which is newly generated so as to correspond to a product sold by the registered associated company.

Further, the main server may determine how to transmit a mobile gift certificate to be issued to the user terminal based on country information.

Further, the plurality of countries includes a first country and a second country, and when information request for a mobile gift certificate available in a second country is received from the first user terminal of the first country, a main server of the first country receives information about the mobile gift certificate available in the second country from a main server of the second country to provide the information to the first user terminal.

Further, when a signal requesting to issue a mobile gift certificate available in a second country is received from the first user terminal to a second user terminal of the second country, the main server of the first country may transmit gift information including information of a mobile gift certificate to be issued, identification information of the first user terminal, and identification information of the second user terminal to the main server of the second country.

Further, the main server of the second country may issue the mobile gift certificate to be issued to the second user terminal based on the gift information.

Further, according to an exemplary embodiment of the present disclosure, a global mobile gift certificate platform may further include an integrated management server which receives authentication information about the mobile gift certificate from a usage place terminal provided in the usage place when the issued mobile gift certificate is used in a predetermined usage place and assigns an administrator Admin to the main server and an administrator Admin to the brand server, provided in each of the plurality of countries.

In the meantime, according to a first exemplary embodiment of the present disclosure, a method for presenting a mobile gift certificate between countries based on a global mobile gift certificate platform may include: receiving country information of a second user terminal which receives a mobile gift certificate from a first user terminal of a first country; transmitting information of a mobile gift certificate available in a second country to the first user terminal when the country information is the second country; receiving a gift request including information of a mobile gift certificate to be issued and identification information of the second user terminal, from the first user terminal; and issuing the mobile gift certificate to be issued to the second user terminal based on the gift request.

Further, in the transmitting of the information of a mobile gift certificate, a purchase page for a mobile gift certificate available in the second country may be transmitted to the first user terminal.

Further, in the transmitting of the information of a mobile gift certificate, a type of the purchase page transmitted to the first user terminal may be determined based on a channel selection input received from the first user terminal.

In the meantime, according to a second exemplary embodiment of the present disclosure, a method for presenting a mobile gift certificate between countries based on a global mobile gift certificate platform may include: receiving selection information about a mobile gift certificate to be issued from a first user terminal of a first country; receiving a gift request including country information of a second user terminal which receives a mobile gift certificate to be issued and identification information of the second user terminal, from the first user terminal; and issuing the mobile gift certificate to be issued to the second user terminal based on the selection information and the gift request.

The above-described solving means are merely illustrative but should not be construed as limiting the present disclosure. In addition to the above-described embodiments, additional embodiments may be further provided in the drawings and the detailed description of the present disclosure.

According to the above-described solving means, it is possible to provide a global mobile gift certification platform and a method for presenting a mobile gift certificate between countries based on a global mobile gift certificate platform which are capable of providing a mobile gift certificate service which is provided for a customer to buy a mobile gift certificate or present the mobile gift certificate to a third party and a brand-associated service related to a customer relationship management (CRM), such as a benefit, a reward, or mobile gift certificate payment provided to a customer by a brand.

However, the effect which can be achieved by the present disclosure is not limited to the above-described effects, there may be another effect.

### DESCRIPTION OF DRAWINGS

FIG. 1 is a schematic diagram of a global mobile gift certificate platform according to an exemplary embodiment of the present disclosure.

FIG. 2 is a conceptual view for explaining a process of transmitting a mobile gift certificate to a user terminal and an authentication process when the mobile gift certificate is actually used in a usage place based on a global mobile gift certificate platform according to an exemplary embodiment of the present disclosure.

FIG. 3 is a view illustrating a user interface associated with a mobile gift certificate service of a global mobile gift certificate platform according to an exemplary embodiment of the present disclosure.

FIGS. 4A to 4D are views illustrating a manager interface associated with a brand-associated service of a global mobile gift certificate platform according to an exemplary embodiment of the present disclosure.

FIG. 5 is an operation flowchart of a method for presenting a mobile gift certificate between countries based on a global mobile gift certificate platform according to a first exemplary embodiment of the present disclosure.

FIG. 6 is an operation flowchart of a method for presenting a mobile gift certificate between countries based on a global mobile gift certificate platform according to a second exemplary embodiment of the present disclosure.

### BEST MODE

Hereinafter, the present disclosure will be described more fully hereinafter with reference to the accompanying drawings, in which exemplary embodiments of the present disclosure are shown. However, the present disclosure can be realized in various different forms, and is not limited to the embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” or “indirectly coupled” to the other element through a third element.

Through the specification of the present disclosure, when one member is located “on”, “above”, “on “an upper portion”, “below”, “under”, and “on a lower portion” of the other member, the member may be adjacent to the other member or a third member may be disposed between the above two members.

In the specification of the present disclosure, unless explicitly described to the contrary, the word “comprise” and variations such as “comprises” or “comprising”, will be understood to imply the inclusion of stated elements but not the exclusion of any other elements.

The present disclosure relates to a global mobile gift certificate platform and a method for presenting a mobile gift certificate between countries based on a global mobile gift certificate platform.

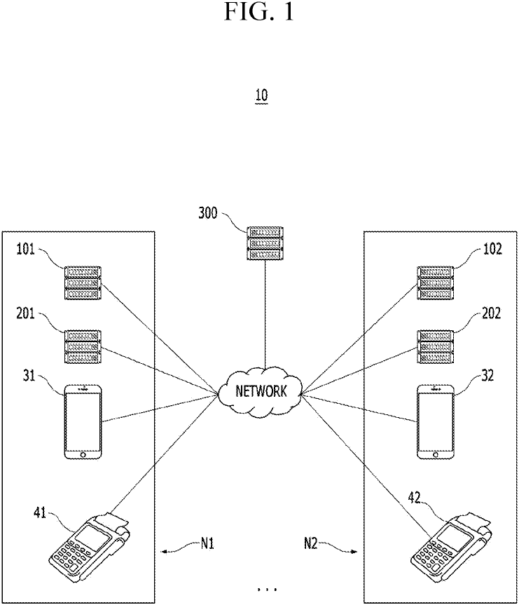

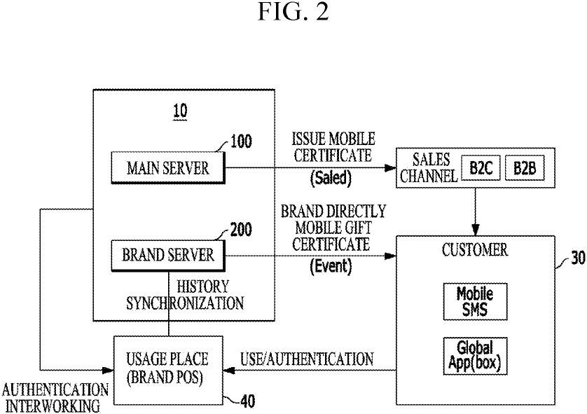

FIG. 1 is a schematic diagram of a global mobile gift certificate platform according to an exemplary embodiment of the present disclosure. Further, FIG. 2 is a conceptual view for explaining a process of transmitting a mobile gift certificate to a user terminal and an authentication process when the mobile gift certificate is actually used in a usage place based on a global mobile gift certificate platform according to an exemplary embodiment of the present disclosure.

Referring to FIGS. 1 and 2, a global mobile gift certificate platform 10 according to an exemplary embodiment of the present disclosure (hereinafter, simply referred to as a “global mobile gift certificate platform 10”) may include a main server 100, a brand server 200, an integrated management server 300, a user terminal 30, and a usage place terminal 40. Further, referring to FIG. 1, the global mobile gift certificate platform 10 may include individual servers for a plurality of countries (in other words, a plurality of countries where the global mobile gift certificate platform 10 enters) associated with the global mobile gift certificate platform 10. In other words, the global mobile gift certificate platform 10 may include a main server 100 and a brand server 200 which are individually provided for the plurality of countries including a first country N1 and a second country N2.

That is, referring to FIG. 1, the main server 100 of the global mobile platform 10 may include a main server 101 of a first country and a main server 102 of a second country. Further, the brand server 200 of the global mobile platform 10 may include a brand server 201 of the first country and a brand server 202 of the second country. In the following description of the detailed function and operation of the global mobile platform 10 disclosed in the present disclosure, it is mainly described that the function and the operation are performed in the first country and the second country. However, the present disclosure is not limited thereto and the global mobile platform 10 may be provided for a plurality of countries such as a third country and a fourth country, other than the first country and the second country. Further, for the convenience of description, a user terminal of the first country is referred to as a first user terminal 31 and a user terminal of the second country is referred to as a second user terminal 32.

The main server 100, the brand server 200, the integrated management server 300, the user terminal 30, and the usage place terminal 40 may communicate with each other via the network 20. The network 20 means a connection structure which allows information exchange between nodes such as terminals or servers. Examples of the network 20 include 3rd generation partnership project (3GPP) network, a long term evolution network, a 5G network, a world interoperability for microwave access (WIMAX) network, Internet, a local area network (LAN), wireless local area network (Wireless LAN), wide area network (WAN), a personal area network (PAN), a Wi-Fi network, a Bluetooth network, a satellite broadcasting network, an analog broadcasting network, and a digital multimedia broadcasting (DMB) network, but are not limited thereto.

For example, the user terminal 30 may include all kinds of wireless communication devices such as a smart phone, a smart pad, a tablet PC, a personal communication system (PCS), a global system for mobile communication (GSM), a personal digital cellular (PDC), a personal handyphone system (PHS), a personal digital assistant (PDA), an international mobile communication (IMT)-2000, code division multiple access (CDMA)-2000, W-code division multiple access (W-CDMA), and a wireless broadband internet (Wibro) terminal.

The usage place terminal 40 may refer to a device (a sort of kiosk terminal or a POS terminal) which sells and manages products provided in a product provider which is operated offline. Further, the usage place terminal 40 may be associated with a usage place server (not illustrated) which operates and manages a product sales site build on online by a mobile gift certificate usage place.

In the description of the exemplary embodiment of the present disclosure, a “mobile gift certificate” may refer to a value exchange means which is issued intangibly online or on mobile, rather than a physical form (for example, a paper type or a card). The user may exchange the mobile gift certificate into various products (concepts having goods and tangible/intangible services) or present (transfer) the mobile gift certificate to the other user online or offline. That is, the mobile gift certificate may refer to all types of value exchange means which are directly used by the user or are presented to the third party to be used.

Further, in the present disclosure, the mobile gift certificate may include various forms such as mobile coupons, gift certificates, tickets, and points, which are transmitted/received between servers or user terminals electronically/mobile and are directly used online or offline or are exchangeable with products/services. That is, the mobile gift certificate of the present disclosure may be understood as a concept including all mobile gift certificates which are transmitted/received online and exchanged with arbitrary products/services regardless of a specific form or a service providing method.

The main server 100 may provide a mobile gift certificate service including management of mobile gift certificate and issuance of a mobile gift certificate to the user terminal 30. Further, the main server 100 may be individually provided in each of the plurality of countries to provide mobile gift certificate service to each of the plurality of countries associated with the global mobile gift certificate platform 10.

Further, the main server 100 may have a right to register an associated company and a right to delete the associated company. Further, the main server 100 may have a right to register a mobile gift certificate associated with the registered associated company and a right to delete the mobile gift certificate.

Here, according to the exemplary embodiment of the present disclosure, the associated company refers to a principal agent that provides products or services corresponding to the mobile gift certificate when the mobile gift certificate associated with the product or the service is provided (sold) to the user (consumer) through the global mobile gift certificate platform 10 and a user who has the mobile gift certificate presents the mobile gift certificate to a usage place. For example, the associated company may be a concept including a “brand” which operates the brand server 200 in the present disclosure and manages the reward payment and mobile gift certificate payment to the customer through the brand server 200. As another example, the associated company may refer to a principal agent that does not operate the brand server 200, but registers a mobile gift certificate associated with the product or the service provided by the associated company to the main server 100 to request the main server 100 to sell the mobile gift certificate to the user (consumer). In other words, the associated company of the present disclosure may refer to a term that collectively refers to a principal agent that sells the mobile gift certificate associated with the product/service provided by the associate company through the main server 100 of the global mobile gift certificate platform 10.

Further, according to the exemplary embodiment of the present disclosure, a registration right of the mobile gift certificate held by the main server 100 may include a right to register a first type mobile gift certificate which has been provided in advance by the registered associated company. Further, a registration right of the mobile gift certificate held by the main server 100 may include a right to register a second type mobile gift certificate which is newly generated so as to correspond to a product sold by the registered associated company.

Specifically, with regard to the first type mobile gift certificate, when there is a mobile gift certificate which is provided (sold) in advance by the associated company, the main server 100 registers the mobile gift certificate provided in advance by the associated company in the main server 100 to allow the user to purchase or present the mobile gift certificate.

The second type mobile gift certificate is a mobile gift certificate which is newly generated for an associated company which does not provide (sell) products or services in the form of a mobile gift certificate, such as a small-size associated company which is operated (locally) in a specific area to be sold to users through the main server 100. The global mobile gift certificate platform 10 of the present disclosure may newly generate and register the mobile gift certificate based on products or services sold by the associated company to allow a user (consumer) to access products or services of an associated company which is locally operated or has a small size based on the mobile gift certificate.

With regard to this, according to the exemplary embodiment of the present disclosure, the main server 100 may newly generate the second type mobile gift certificate based on item information and price information of products or services which are provided (sold) by the associated company and received from an associated company server (not illustrated). Further, according to the exemplary embodiment of the present disclosure, the main server 100 may determine a number of registered newly generated second type mobile gift certificates (number of sales) based on sales information of the associated company received from the associated company server (not illustrated), but is not limited thereto.

Further, the main server 100 may determine a transmission method of a mobile gift certificate to be issued to the user terminal 30 based on country information. Further, the main server 100 may determine a transmission method of a mobile gift certificate to be issued to the user terminal 30 based on an authentication method in a usage place of the mobile gift certificate to be issued.

According to the exemplary embodiment of the present disclosure, when the main server 100 determines the transmission method of the mobile gift certificate to be issued, it may mean that during a process of transmitting identification information of the mobile gift certificate to be issued to the user terminal 30 of a recipient, a format of the identification information is determined as a predetermined type. For example, the format of the identification information of the mobile gift certificate to be issued may include a barcode, a QR code, a PIN number, or a SMS/MMS/LMS based URL link.

For better understanding, for example, in the main server 101 of the first country, a mobile communication system which is operated in the first country does not support a multimedia messaging service (MMS), a mobile gift certificate issued to a user terminal 31 of the first country may be transmitted with a format excluding the MMS based URL link. As another example, when it is required for the payment system built by the associated company to which the mobile gift certificate to be issued is to be used that the identification information of the mobile gift certificate has a predetermined format in consideration of various conditions, the main server 101 of the first country may issue the mobile gift certificate to the user terminal 30 so as to satisfy the format in consideration of the format.

Further, according to the exemplary embodiment of the present disclosure, the main server 100 may determine a medium in which the mobile gift certificate to be issued is stored based on type information of the user terminal 30 which receives the mobile gift certificate to be issued.

For example, when an application (hereinafter, simply referred to as “global App”) associated with the global mobile gift certificate platform 10 is installed in the user terminal 30, the main server 100 may transmit identification information of the mobile gift certificate to be issued to a reception box (gift box) of the global App of the user terminal 30. As another example, when the global App is not installed in the user terminal 30, the main server 100 may transmit the identification information of the mobile gift certificate to be issued to the user terminal in the form of a message (for example, the above-described MMS/SMS/LMS, etc.). Further, according to the exemplary embodiment of the present disclosure, the main server 100 may operate to transmit information (for example, an application installation link) for installing the global App together with identification information for the mobile gift certificate to be issued to the user terminal 30 which does not have the global App installed therein to be issued with the mobile gift certificate to be issued in the form of a message.

Further, the main server 101 of the first country may receive a request for information about a mobile gift certificate available in the second country from the first user terminal 31 of the first country. Here, when the request for information about a mobile gift certificate available in the second country is received, it means that the user of the first user terminal 31 applies a user input for selecting the second country from a country selection tab provided through the global App. At this time, the main server 101 of the first country may receive information about a mobile gift certificate available in the second country from the main server 102 of the second country to provide the information to the first user terminal 31.

At this time, the main server 101 of the first country may interpret information about a mobile gift certificate available in the second country transmitted from the main server 102 of the second country as needed (for example, according to the request of the first user) into a language of the first country and provide the information. Further, the main server 101 of the first country may convert and provide price information of the mobile gift certificate included in information about a mobile gift certificate available in the second country transmitted from the main server 102 of the second country based on currency information in the first country, as needed (for example, according to the request of the first user).

Further, the main server 101 of the first country may receive a signal from the first user terminal 31 to request the second user terminal 32 of the second country to issue a predetermined mobile gift certificate (a mobile gift certificate to be issued) available in the second country. As the main server 101 of the first country receives the above-described issuance request signal, the main server 101 of the first country transmits gift information including information of the mobile gift certificate to be issued, identification information of the first user terminal 31, and identification information of the second user terminal 32 to the main server 102 of the second country. Here, identification information of the user terminals 31 and 32 may refer to account information (ID, etc.) of each of users for the global App.

Thereafter, the main server 102 of the second country may issue the mobile gift certificate to be issued to the second user terminal 32 based on the gift information received from the main server 101 of the first country.

The brand server 200 may provide a brand associated service including mobile gift certificate payment and reward payment to a user terminal of a customer of the brand. Further, the brand server 200 may be individually provided in each of the plurality of countries to provide a brand-associated service to each of the plurality of countries associated with the global mobile gift certificate platform 10.

Specifically, the brand server 200 may transmit a reward including stamps, mileages, and point accumulation provided as benefits based on a purchase history, a visit history, and an event participation history of the customer to the user terminal 30 of the customer and manage the reward providing history for every user. Further, the brand server 200 may present the mobile gift certificate to a customer who satisfies a predetermined condition based on the purchase history, the visit history, and the event participation history of the customer and manage the mobile gift certificate payment history for every customer.

Further, according to the exemplary embodiment of the present disclosure, when a brand operates a plurality of branches (stores), the brand server 200 may provide a brand associated service including reward management for every branch and mobile gift certificate payment management for every branch. For example, the brand server 200 may allocate a type of the mobile gift certificate which is presented to the customer in the selected branch and an amount of presented mobile gift certificates to the corresponding branch.

Further, according to the exemplary embodiment of the present disclosure, the brand server 200 may manage statistical information about a reward providing status for every branch. Further, the brand server 200 may manage statistical information about the mobile gift certificate presenting status for every branch and mobile gift certificate based sales status.

When the mobile gift certificate issued to the user terminal 30 is used in a predetermined usage place, the integrated management server 300 may receive authentication information about the mobile gift certificate from the usage place terminal 40 provided in the usage place.

Further, the integrated management server 300 may assign an administrator Admin to the main server 100 provided for each of the plurality of countries associated with the global mobile gift certificate platform 10 and an administrator Admin to the brand server 200.

According to the exemplary embodiment of the present disclosure, the global mobile gift platform 10 may be built based on a cloud service. For example, the global mobile gift certificate platform 10 may be built based on a cloud service provided from Amazon web services (AWS), but is not limited thereto. Specifically, when the integrated management server 300 is implemented based on the above-described AWS, the integrated management server 300 may hold a Software as a Service (SaaS) based Admin branch logic which provides a software service built in the main server 100 and the brand server 200 provided for each of the plurality of countries as Admin. With regard to this, the global mobile gift certificate platform 10 disclosed in the present disclosure is operated to build the entire platform based on the cloud and assign Admin to every entering country in the form of a software service to easily expand the platform when the global mobile gift certificate platform enters to a new country.

Referring to FIG. 2, the global mobile gift certificate platform 10 is built to provide a mobile gift certificate service and a brand associated service in each of the plurality of countries by means of the admin branch logic branched for each of the plurality of countries. The user (customer) may integratively use the brand association service which manages a mobile gift certificate service to purchase, present, and use the mobile gift certificate and a reward (stamp accumulation, mileage accumulation, point accumulation, and discount coupons) for every brand through a global App installed in the user terminal 30, regardless of the country of the user.

According to the exemplary embodiment of the present disclosure, the authentication information about the mobile gift certificate that is received by the integrated management server 300 from the usage place terminal 40 may vary depending on a mobile gift certificate usage/authentication environment of the usage place. For example, when the communication method of the usage place terminal 40 and the integrated management server 300 is based on the unified API, the authentication information of the mobile gift certificate may be transmitted from the usage place terminal 40 to the integrated management server 300 based on the integrated API (for example, TCP/IP type, HTTP type, and DLL type), but is not limited thereto. As another example, when a predetermined Redemption agent program is mounted in the usage place terminal 40, the integrated management server 300 may receive authentication information of the mobile gift certificate from the usage place terminal 40 by means of the Redemption agent program. As another example, when a validity is confirmed by inquiring the mobile gift certificate requested to be used based on a separate web administrator, the usage place terminal 40 may operate to process the use of the mobile gift certificate and transmit the result to the integrated management server 300. Further, when the above-described global App is installed in the usage place terminal 40, a user (a usage place manager) of the usage place terminal 40 accesses (logs in) the global App with an account having a mobile gift certificate use manager authority to confirm identification information and validity of the mobile gift certificate by means of the global App to process the use of the mobile gift certificate. The integrated management server 300 may receive the processing result by means of the global App.

By doing this, the integrated management server 300 of the global mobile gift certificate platform 10 of the present disclosure may package and collectively hold usage and authentication methods of an available mobile gift certificate based on the type of the usage place terminal 40 or the environment of the usage place such that the mobile gift certificate service is operated in various environments in consideration of different mobile gift certificate usage environments for every usage place (store) of the mobile gift certificate for every country.

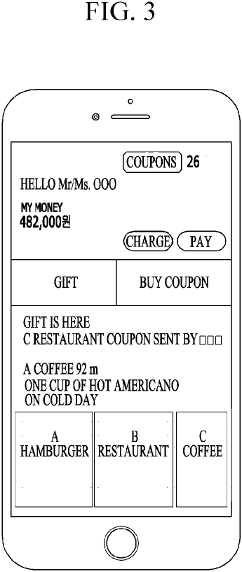

Hereinafter, the user interface displayed on the user terminal 30 with regard to the mobile gift certificate service of the global mobile gift certificate platform 10 will be described with reference to FIG. 3.

FIG. 3 is a view illustrating a user interface associated with a mobile gift certificate service of a global mobile gift certificate platform according to an exemplary embodiment of the present disclosure.

The user interface illustrated in FIG. 3 may be a screen which is output through the above-described global App installed in the user terminal 30. Referring to FIG. 3, the user interface associated with the mobile gift certificate service may display information about an amount charged by the user of the user terminal 30 to purchase or present the mobile gift certificate. Further, referring to FIG. 3, the user interface associated with the mobile gift certificate service may include a button (“buy coupon”) accessing a purchase page of the mobile gift certificate for the user of the user terminal 30 to directly use the mobile gift certificate and a button (“gift”) accessing a purchase page of a mobile gift certificate to present a predetermined mobile gift certificate to a third party.

Further, referring to FIG. 3, the user interface associated with the mobile gift certificate service may display gift information of a mobile gift certificate which is presented to the user terminal 30 from another user or presented as a reward from a predetermined brand. Further, referring to FIG. 3, the user interface associated with the mobile gift certificate service may display a promotion area to induce a user of the user terminal 30 to buy a predetermined mobile gift certificate. For example, in the promotion area, information of a brand having a nearby store based on location information of the user terminal or information of a mobile gift certificate available in the brand may be displayed. As another example, in the promotion area, information of a recommended brand reflecting a user’s preference based on the accumulated and stored mobile gift certificate usage histories for the user of the user terminal 30 or information of a mobile gift certificate available for the recommended brand may be displayed.

As another example, in the promotion area, location information of an acquaintance user terminal determined based on contacts or address directory, or information of the recommended brand based on a mobile gift certificate usage history accumulated for the acquaintance user terminal, or information of the mobile gift certificate available in the recommended brand may be displayed to induce the user of the user terminal 30 to present the mobile gift certificate to an acquaintance based on the contacts or address directory stored in the user terminal 30. At this time, when the acquaintance is located in a country different from the country where the user is located, information of a brand of the corresponding country and information of a mobile gift certificate available in the brand are acquired from the main server 100 of the corresponding country to be displayed on the user interface of the user terminal 30.

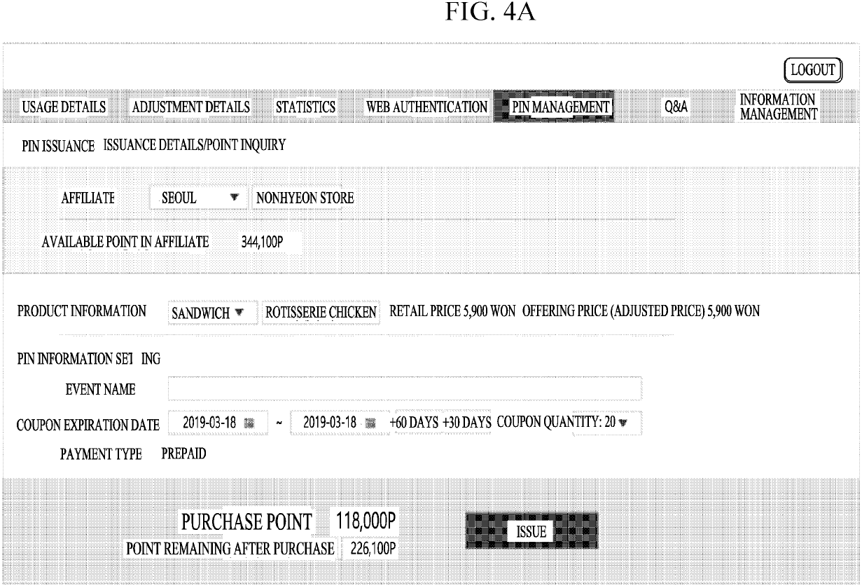

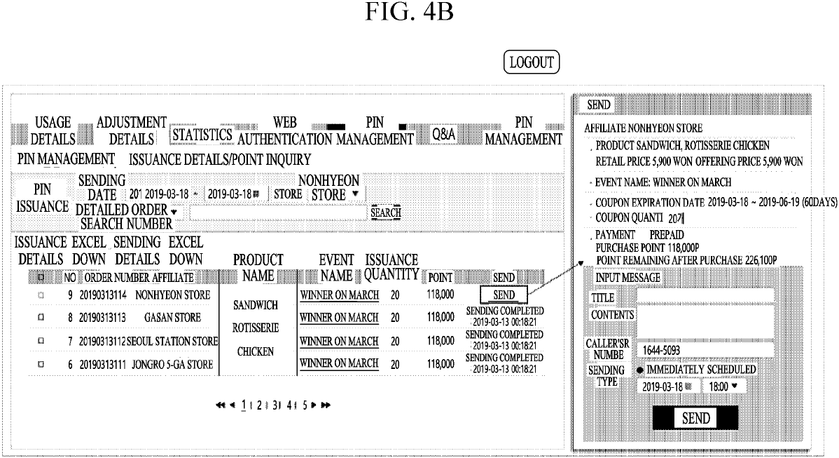

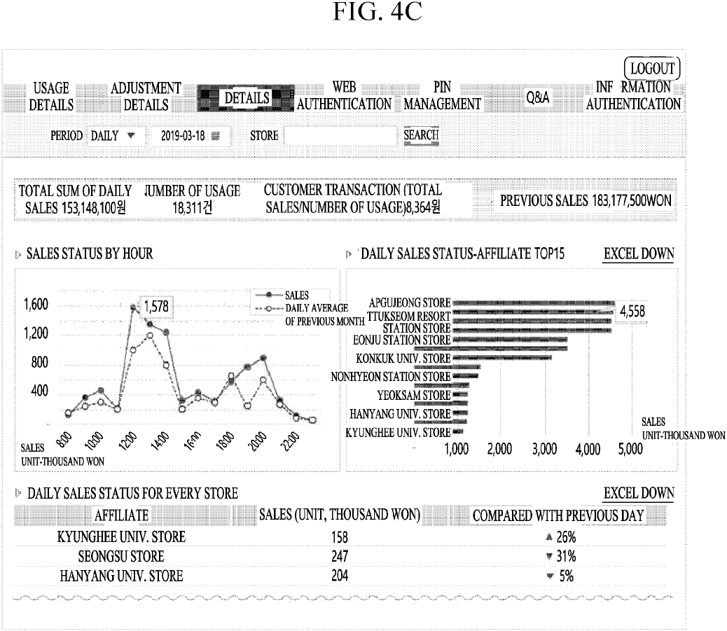

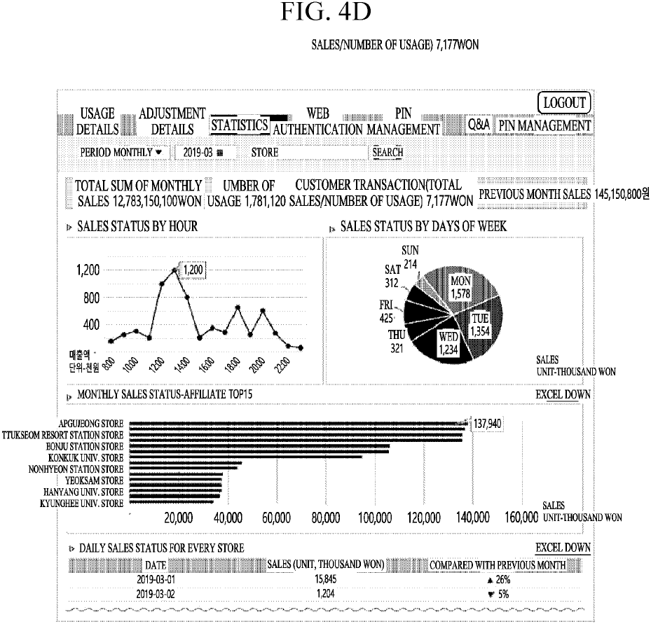

Hereinafter, with regard to the brand association service of the global mobile gift certificate platform 10, a manager interface displayed on a brand manager terminal (not illustrated) will be described with reference to FIGS. 4A to 4D.

FIGS. 4A to 4D are views illustrating a manager interface associated with a brand associated service of a global mobile gift certificate platform according to an exemplary embodiment of the present disclosure.

Specifically, FIGS. 4A and 4B illustrate a manager interface displayed to allocate (transmit) a mobile gift certificate which is presented as a reward to a customer of a branch at every branch of the brand in a manager terminal (not illustrated) of the brand associated with the brand server 200 and FIGS. 4C and 4D illustrate a manager interface displayed to confirm sales statistical information of mobile gift certificates for every branch of the brand in the manager terminal (not illustrated) of a brand associated with the brand server 200.

Referring to FIGS. 4A and 4B, the brand server 200 receives a branch selection input and allocation information (an item type, quantity information, consumed points, and event name) of the mobile gift certificate from the manager terminal (not illustrated) to allocate a mobile gift certificate to the selected branch. Accordingly, benefits or events are provided to customers based on the allocated mobile gift certificate or a mobile gift certificate is presented to a customer who satisfies a predetermined condition at every branch of the brand.

Referring to FIG. 2 which has been described, the brand server 200 collects the history of the mobile gift certificate used in the corresponding usage place (branch) from the user terminal 40 provided in every branch of the brand (history synchronization of FIG. 2). Further, referring to FIGS. 4C and 4D, the brand server 200 derives sales history information for a predetermined time range (for example, for every time, daily, or monthly) by processing the mobile gift certificate usage history for every usage place (branch) collected from the usage place terminal 40 and visualizes the sales history information to display the sales history information. For example, the brand server 200 may provide the sales history information in the form of a chart or a graph.

Further, according to the exemplary embodiment of the present disclosure, when there are ERP, MRP, MIS, CRM, POS systems constructed for the corresponding brand in advance, the brand server 200 may be provided to interwork with an API option of the ERP, MRP, MIS, CRM, or POS system.

Hereinafter, an operation flow of the present disclosure will be described in brief based on the above detailed description.

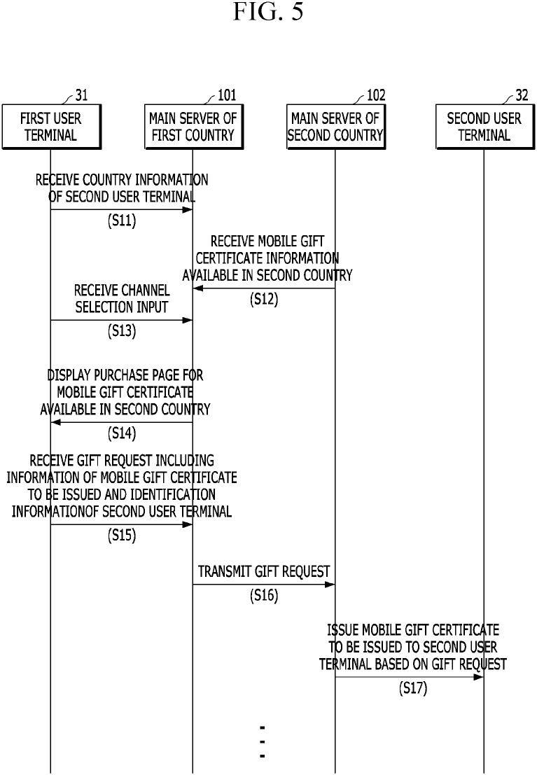

FIG. 5 is an operation flowchart of a method for presenting a mobile gift certificate between countries based on a global mobile gift certificate platform according to a first exemplary embodiment of the present disclosure.

The method for presenting a mobile gift certificate between countries based on a global mobile gift certificate platform according to a first exemplary embodiment of the present disclosure illustrated in FIG. 5 may be performed by the above-described global mobile gift certificate platform 10. Accordingly, even though contents are omitted below, if the contents have been described for the global mobile gift certificate platform 10, the contents may also be applied to the description of the method for presenting a mobile gift certificate between countries based on a global mobile gift certificate platform according to a first exemplary embodiment of the present disclosure in the same way.

Referring to FIG. 5, in step S11, a main server 101 of a first country may receive country information of a second user terminal 32 which receives a mobile gift certificate from a first user terminal 31 of the first country.

Next, in step S12, when the received country information of the second user terminal 32 is the second country, the main server 101 of the first country requests the main server 102 of the second country information of a mobile gift certificate available in the second country to receive information about a mobile gift certificate available in the second country from the main server 102 of the second country.

Next, in step S13, the main server 101 of the first country receives a channel selection input from the first user terminal 31. Here, the channel selection input refers that a user selects an application or a web site for a purchase page to proceed the purchase of a mobile gift certificate based on a specific channel among channels such as Lazadea, Tokopedia, Kakaotalk, Facebook which are provided for every country in different ways.

Next, in step S14, the main server 101 of the first country may provide information about a mobile gift certificate available in the second country received from the main server 102 of the second country to the first user terminal 31.

Specifically, in step S14, the main server 101 of the first country may transmit a purchase page for the mobile gift certificate available in the second country to the first user terminal 31. Further, in step S14, the main server 101 of the first country may determine a type of the purchase page transmitted to the first user terminal 31 (in other words, displayed on the first user terminal 31) based on the channel selection input received from the first user terminal 31.

Next, in step S15, the main server 101 of the first country may receive a gift request including information of a mobile gift certificate to be issued and identification information of the second user terminal 32 from the first user terminal 31.

Next, in step S16, the main server 101 of the first country may transmit the received gift request to the main server 102 of the second country.

Next, in step S17, the main server 102 of the second country may issue a mobile gift certificate to be issued to the second user terminal 32 based on the received gift request.

In the above-description, steps S11 to S17 may be further divided into additional steps or combined as smaller steps depending on an implementation example of the present disclosure. Further, some steps may be omitted if necessary and the order of steps may be changed.

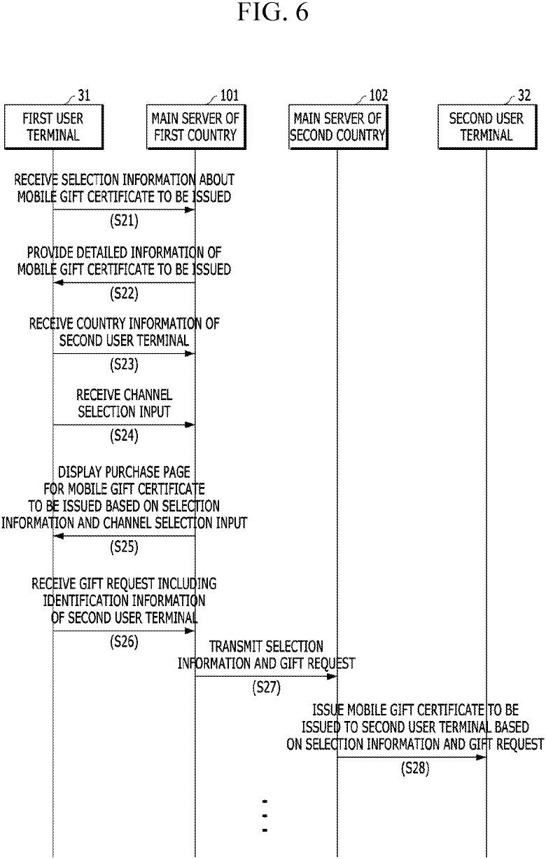

FIG. 6 is an operation flowchart of a method for presenting a mobile gift certificate between countries based on a global mobile gift certificate platform according to a second exemplary embodiment of the present disclosure.

The method for presenting a mobile gift certificate between countries based on a global mobile gift certificate platform according to a second exemplary embodiment of the present disclosure illustrated in FIG. 6 may be performed by the above-described global mobile gift certificate platform 10. Accordingly, even though contents are omitted below, if the contents have been described for the global mobile gift certificate platform 10, the contents may also be applied to the description of the method for presenting a mobile gift certificate between countries based on a global mobile gift certificate platform according to a second exemplary embodiment of the present disclosure in the same way.

Referring to FIG. 6, in step S21, a main server 101 of a first country may receive selection information about a mobile gift certificate to be issued from a first user terminal 31 of the first country.

Next, in step S22, the main server 101 of the first country may provide detailed information about the mobile gift certificate to be issued selected by the user of the first user terminal 31 based on the received selection information.

Next, in step S23, the main server 101 of the first country may receive country information of the second user terminal 32 which receives the mobile gift certificate to be issued selected from the first user terminal 31.

Next, in step S24, the main server 101 of the first country may receive a channel selection input from the first user terminal 31.

Next, in step S25, the main server 101 of the first country may transmit a purchase page for the mobile gift certificate to be issued to the first user terminal 31 based on the received selection information about the mobile gift certificate to be issued and the channel selection input.

Next, in step S26, the main server 101 of the first country may receive a gift request including identification information of the second user terminal 32 from the first user terminal 31.

Next, in step S27, the main server 101 of the first country may transmit the received gift request to the main server 102 of the second country.

Next, in step S28, the main server 102 of the second country may issue a mobile gift certificate to be issued to the second user terminal 32 based on the received gift request.

In the above-description, steps S21 to S28 may be further divided into additional steps or combined as smaller steps depending on an implementation example of the present disclosure. Further, some steps may be omitted if necessary and the order of steps may be changed.

The method for presenting a mobile gift certificate between countries based on a global mobile gift certificate platform according to the exemplary embodiment of the present disclosure may be implemented as a program command which may be executed by various computers to be recorded in a computer readable medium. The computer readable medium may include solely a program command, a data file, and a data structure or a combination thereof. The program instruction recorded in the medium may be specifically designed or constructed for the present disclosure or known to those skilled in the art of a computer software to be used. Examples of the computer readable recording medium include a magnetic media such as a hard disk, a floppy disk, or a magnetic tape, an optical media such as a CD-ROM or a DVD, a magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may be configured to operate as one or more software modules in order to perform the operation of the present disclosure and vice versa.

Further, the above-described method for presenting a mobile gift certificate between countries based on a global mobile gift certificate platform may be implemented as a computer program or an application which is executed by a computer and is stored in a recording medium.

The above-description of the present disclosure is illustrative only and it is understood by those skilled in the art that the present disclosure may be easily modified to another specific type without changing the technical spirit of an essential feature of the present disclosure. Thus, it is to be appreciated that the embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

1. A global mobile gift certificate platform, comprising:
a main server which provides a mobile gift certificate service including mobile gift certificate management and mobile gift certificate issuance to a user terminal; and
a brand server which provides a brand associated service including present of mobile gift certificate and reward payment to a user terminal of a customer of a brand,
wherein the main server and the brand server are individually provided for each of a plurality of countries to provide the mobile gift certificate service and the brand associated service to each of the plurality of countries associated with the global mobile gift certificate platform.

2. The global mobile gift certificate platform according to claim 1, wherein the main server holds an associated company registration right and an associated company deletion right and a right to register a mobile gift certificate associated with the registered associated company and a right to delete the mobile gift certificate.

3. The global mobile gift certificate platform according to claim 2, wherein the mobile gift certificate registration right is a right to register at least one of a first type mobile gift certificate which has been provided in advance by the registered associated company and a second type mobile gift certificate which is newly generated so as to correspond to a product sold by the registered associated company.

4. The global mobile gift certificate platform according to claim 1, wherein the main server determines how to transmit a mobile gift certificate to be issued to the user terminal based on country information.

5. The global mobile gift certificate platform according to claim 1, wherein the plurality of countries includes a first country and a second country, and when information request for a mobile gift certificate available in a second country is received from the first user terminal of the first country, a main server of the first country receives information about the mobile gift certificate available in the second country from a main server of the second country to provide the information to the first user terminal.

6. The global mobile gift certificate platform according to claim 5, wherein when a signal requesting to issue a mobile gift certificate available in the second country is received from the first user terminal to a second user terminal of the second country, the main server of the first country transmits gift information including information of a mobile gift certificate to be issued, identification information of the first user terminal, and identification information of the second user terminal to the main server of the second country and the main server of the second country issues the mobile gift certificate to be issued to the second user terminal based on the gift information.

7. The global mobile gift certificate platform according to claim 1, further comprising:
an integrated management server which receives authentication information about the mobile gift certificate from a usage place terminal provided in the usage place when the issued mobile gift certificate is used in a predetermined usage place and assigns an administrator Admin to the main server and an administrator Admin to the brand server, provided in each of the plurality of countries.

8. A method for presenting a mobile gift certificate between countries based on a global mobile gift certificate platform, the method comprising:
receiving country information of a second user terminal which receives a mobile gift certificate from a first user terminal of a first country;
transmitting information of a mobile gift certificate available in a second country to the first user terminal when the country information is the second country;
receiving a gift request including information of a mobile gift certificate to be issued and identification information of the second user terminal, from the first user terminal; and
issuing the mobile gift certificate to be issued to the second user terminal based on the gift request.

9. The method for presenting a mobile gift certificate between countries according to claim 8, wherein in the transmitting of the information of a mobile gift certificate, a purchase page for a mobile gift certificate available in the second country is transmitted to the first user terminal and a type of the purchase page transmitted to the first user terminal is determined based on a channel selection input received from the first user terminal.

10. A method for presenting a mobile gift certificate between countries based on a global mobile gift certificate platform, the method comprising:
receiving selection information about a mobile gift certificate to be issued from a first user terminal of a first country;
receiving a gift request including country information of a second user terminal which receives the mobile gift certificate to be issued and identification information of the second user terminal, from the first user terminal; and
issuing the mobile gift certificate to be issued to the second user terminal based on the selection information and the gift request.
